(19) United States
(12) Patent Application Publication
(10) Pub. No.: US 2019/0165435 A1
(43) Pub. Date: May 30, 2019

(54) BATTERY THERMAL MANAGEMENT METHOD AND APPARATUS

(71) Applicant: Samsung Electronics Co., Ltd., Suwon-si (KR)

(72) Inventors: Ji-Young JEONG, Hwaseong-si (KR); Young Hun SUNG, Hwaseong-si (KR)

(73) Assignee: Samsung Electronics Co., Ltd., Suwon-si (KR)

(21) Appl. No.: 15/981,037

(22) Filed: May 16, 2018

(30) Foreign Application Priority Data
Nov. 28, 2017 (KR) 10-2017-0160571

(51) Int. Cl. H01M 10/613; H01M 10/625; H01M 10/6563; H01M 10/6567

(52) U.S. Cl. CPC H01M 10/613; H01M 10/625; H01M 2220/20; H01M 10/6567; H01M 10/6563

(57) ABSTRACT

A battery thermal management method and apparatus are provided. The battery thermal management apparatus includes a first flow path of an air refrigerant to cool an upper portion of a battery, and a second flow path of a liquid refrigerant to cool a lower portion of the battery. The battery is cooled using either one or both of the air refrigerant and the liquid refrigerant.

### CROSS-REFERENCE TO RELATED APPLICATIONS

This application claims the benefit under 35 USC § 119(a) of Korean Patent Application No. 10-2017-0160571, filed on Nov. 28, 2017, in the Korean Intellectual Property Office, the entire disclosure of which is incorporated herein by reference for all purposes.

### BACKGROUND

### 1. Field

The following description relates to a battery thermal management method and apparatus.

### 2. Description of Related Art

A battery may include a high-voltage battery pack including a plurality of battery modules. For example, a battery pack may generate a considerable amount of heat during charging and discharging of a battery. In this example, the performance of the battery or the life of the battery may decrease due to the generated heat.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a battery thermal management apparatus includes a first flow path and a second flow path. The first flow path is configured to flow air refrigerant to cool an upper portion of a battery. The second flow path is configured to flow liquid refrigerant to cool a lower portion of the battery. The battery is selectively cooled using either one or both of the air refrigerant and the liquid refrigerant.

The first flow path may be connected to an upper portion of a housing of the battery.

The air refrigerant may be used to cool one or more tabs of the battery disposed at the upper portion of the battery.

One of the tabs may be connected to a heat sink that is perpendicularly configured to a direction in which the air refrigerant flows.

The heat sink may include one or more grooves through which the air refrigerant flows.

A guide member may be configured for turbulent flow of the air refrigerant inside a housing of the battery.

The guide member may be formed on an upper side of the housing.

The second flow path may contact the lower portion of the battery.

The battery may be selectively cooled using either one or both of the air refrigerant and the liquid refrigerant selected based on a temperature of either one or both of the upper portion and the lower portion of the battery.

In response to a temperature of each of the upper portion and the lower portion of the battery being less than or equal to a first threshold temperature, the battery may be cooled through a natural convection of the air refrigerant. In response to a temperature of either one or both of the upper portion and the lower portion of the battery exceeding the first threshold temperature, the battery may be cooled through a forced convection of the air refrigerant induced by an operation of a fan located in the first flow path of the air refrigerant.

In response to a temperature difference between the upper portion and the lower portion of the battery exceeding a second threshold temperature, the battery may be selectively cooled using the air refrigerant and the liquid refrigerant.

The first flow path may be opened and closed based on either one or both of a state of the battery and whether liquid flows into the first flow path.

In another general aspect, a processor implemented battery thermal management method includes cooling a battery using either one or both of an air refrigerant to selectively cool an upper portion of a battery and a liquid refrigerant to cool a lower portion of the battery.

The cooling of the battery may include measuring a temperature of either one or both of the upper portion and the lower portion of the battery; and cooling the battery by selecting either one or both of the air refrigerant and the liquid refrigerant based on the measured temperature.

The cooling of the battery by selectively selecting either one or both of the air refrigerant and the liquid refrigerant based on the measured temperature may include: in response to a temperature of each of the upper portion and the lower portion of the battery being less than or equal to a first threshold temperature, cooling the battery through a natural convection of the air refrigerant; and in response to a temperature of either one or both of the upper portion and the lower portion of the battery exceeding the first threshold temperature, cooling the battery through a forced convection of the air refrigerant induced by an operation of a fan located in a flow path of the air refrigerant.

The cooling of the battery by selectively selecting either one or both of the air refrigerant and the liquid refrigerant based on the measured temperature may include, in response to a temperature difference between the upper portion and the lower portion of the battery exceeding a second threshold temperature, cooling the battery using the air refrigerant and the liquid refrigerant.

A flow path of the air refrigerant may be connected to an upper portion of a housing of the battery.

The air refrigerant may be used to cool one or more tabs of the battery located in the upper portion of the battery.

A flow path of the liquid refrigerant may be in contact with the lower portion of the battery.

A non-transitory computer-readable storage medium storing instructions that, when executed by a processor, may cause the processor to perform the battery thermal management.

Other features and aspects will be apparent from the following detailed description, the drawings, and the claims.

### BRIEF DESCRIPTION OF THE DRAWINGS

FIG. 1 illustrates an example of a battery system.

FIGS. 2A and 2B illustrate examples of a relationship between a flow path and a housing of a battery.

FIGS. 3A and 3B illustrate an example of a guide formed on an upper side of a housing of a battery.

FIGS. 4A and 4B illustrate examples of guides.

FIGS. 5A, 5B and 5C illustrate examples of heat sinks.

FIG. 6 illustrates an example of a battery system with a water leakage prevention apparatus.

FIG. 7 is a flowchart illustrating an example of a battery thermal management method.

FIG. 8 illustrates an example of a battery thermal management apparatus.

FIG. 9 illustrates an example of a vehicle.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined herein, all terms used herein including technical or scientific terms have the same meanings as those generally understood by one of ordinary skill in the art after an understanding of the present disclosure. Terms defined in dictionaries generally used should be construed to have meanings matching with contextual meanings in the related art and the present disclosure, and are not to be construed as an ideal or excessively formal meaning unless otherwise defined herein.

Hereinafter, examples will be described in detail below with reference to the accompanying drawings, and like reference numerals refer to the like elements throughout.

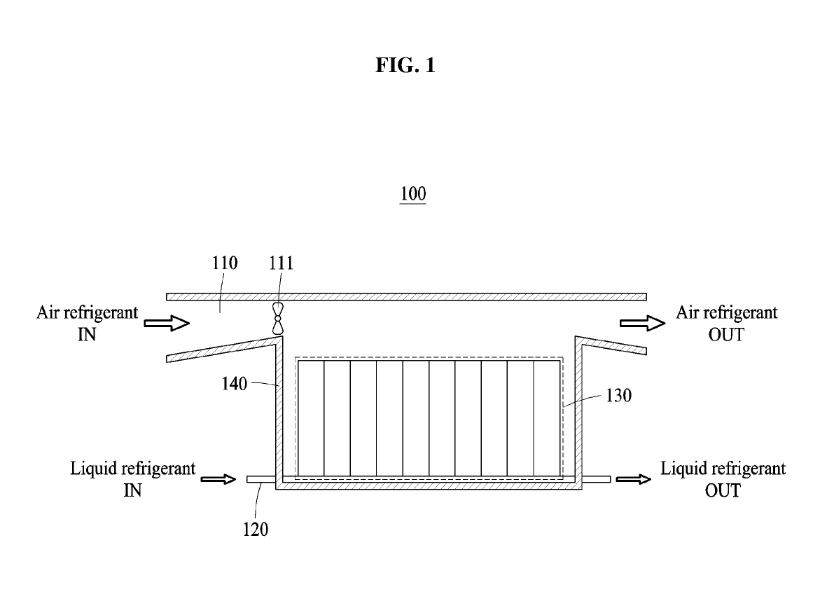

FIG. 1 illustrates an example of a battery system 100.

Referring to FIG. 1, the battery system 100 includes a battery 130 and a battery thermal management apparatus.

The battery 130 supplies power to an apparatus (for example, an electric vehicle (EV) or a hybrid vehicle) including the battery system 100. The battery 130 is, for example, a battery pack including a plurality of battery modules, and each of the battery modules includes a plurality of battery cells.

The battery thermal management apparatus includes a flow path 110 of an air refrigerant and a flow path 120 of a liquid refrigerant, and is configured to cool the battery 130 using either one or both of the air refrigerant and the liquid refrigerant.

The air refrigerant is used to cool an upper portion of the battery 130. The flow path 110 is connected to an upper portion of a housing 140 of the battery 130 and allows the air refrigerant provided through flow path 110 to cool the upper portion of the battery 130. Also, an upper side of the housing 140 is used as one side of the flow path 110, and thus, with this particular structure, it is possible to minimize a volume or a number of additional parts to use the air refrigerant.

A fan 111 is installed in the flow path 110, to cool the battery 130 by a forced convection of the air refrigerant. When the fan 111 does not operate, the battery 130 is cooled by a natural convection of an air refrigerant flowing from an outside of the battery system 100.

The liquid refrigerant is used to cool a lower portion of the battery 130. The flow path 120 is located to be in contact with the lower portion of the battery 130 by passing through a lower portion of the housing 140. For example, because a width of the flow path 120 is greater than a height of the flow path 120, a contact area between the flow path 120 and the battery 130 is maximized. Thus, it is possible to maximize a cooling effect of the battery 130 using the liquid refrigerant. Although not shown in FIG. 1, a pump is installed in the flow channel 120 to allow the liquid refrigerant to circulate.

It is difficult to cool, using the liquid refrigerant, the upper portion of the battery 130 in which a large amount of heat is generated due to a risk such as a leakage of water, and accordingly the liquid refrigerant is used to cool the lower portion of the battery 130 and the air refrigerant is used to cool the upper portion of the battery 130. Thus, it is possible to effectively eliminate a risk such as a leakage of water, and to reduce a temperature difference between the upper portion and the lower portion of the battery 130 while maximizing the cooling effect of the battery 130.

Hereinafter, an example of a structure and an operation of the battery thermal management apparatus will be further described with reference to the drawings.

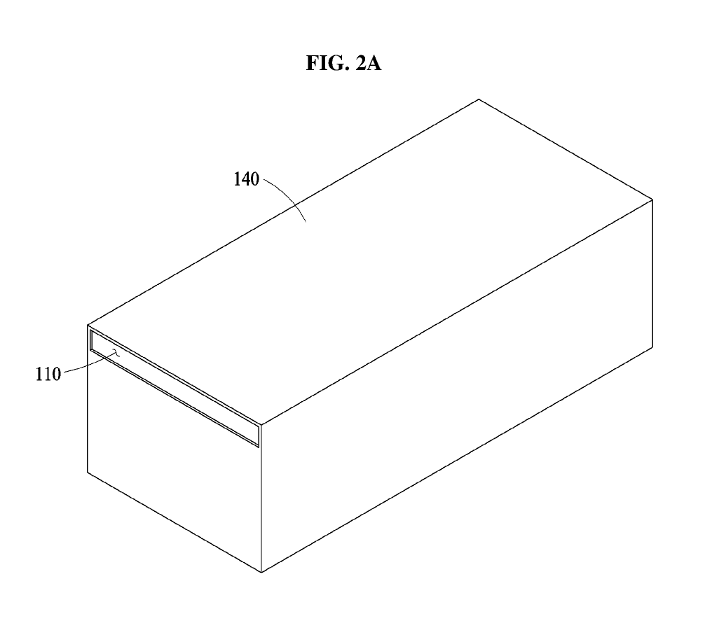

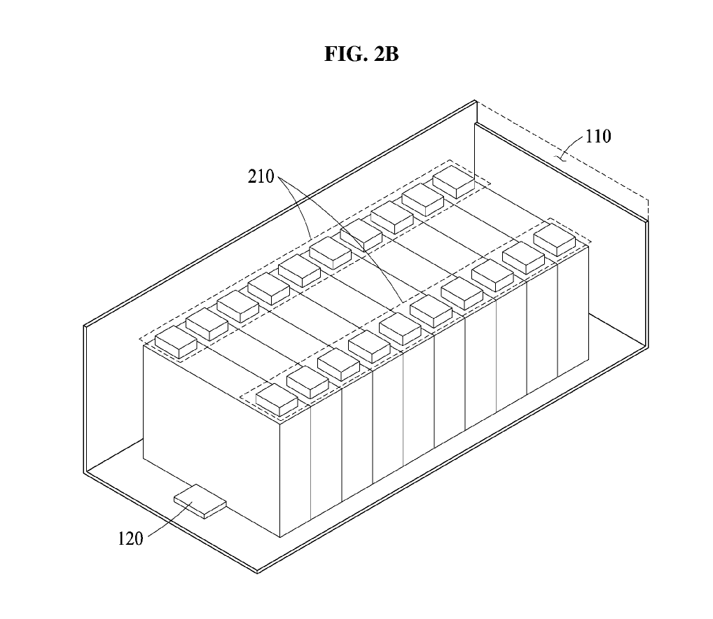

FIGS. 2A and 2B illustrate an example of a relationship between a flow path and a housing of a battery.

FIG. 2A illustrates an exterior of the housing 140. A flow path 110 of an air refrigerant is connected to an upper portion of the housing 140. The air refrigerant flows into the housing 140 through the flow path 110, to mainly cool an upper portion of a battery.

FIG. 2B illustrates an interior of a housing. In FIG. 2B, a battery includes a plurality of battery modules and each of the plurality of battery modules includes a tab 210. The tab 210 is connected to one or more terminals of the battery modules and to one or more printed circuit boards (for example, a battery management system (BMS)). Also, in the tab 210, heat is easily generated during an operation of the battery. The tab 210 is located in an upper portion of the battery, and accordingly is cooled using the air refrigerant.

A flow path 120 of a liquid refrigerant is located to be in contact with a lower portion of the battery, to cool the lower portion of the battery.

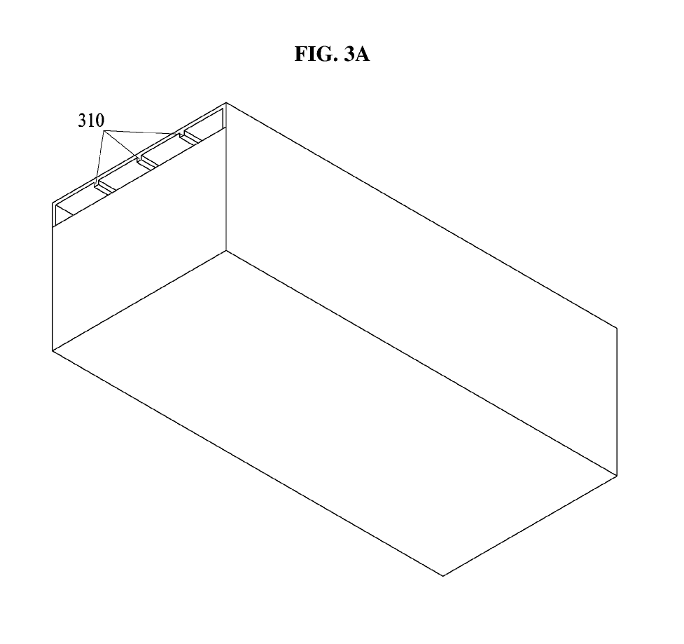

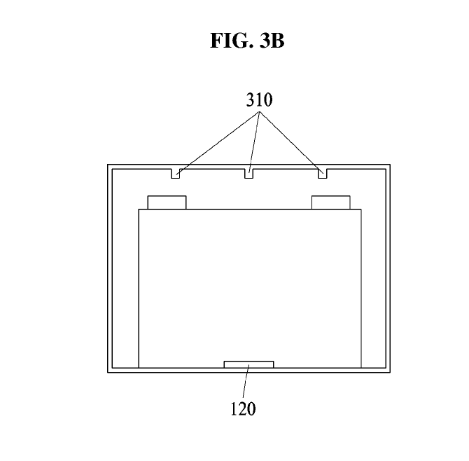

FIGS. 3A and 3B illustrate an example of a guide 310 formed on an upper side of a housing of a battery.

FIG. 3A illustrates an exterior of the housing. The guide 310 is located on the upper side of the housing that is used as one side of a flow path of an air refrigerant, as described above. Air refrigerant flowing past the guide 310 will create a turbulent flow of air inside the housing. For example, the guide 310 forms a predetermined turbulent flow pattern while guiding the overall flow of the air refrigerant in the housing to maximize cooling of the battery by the air refrigerant. FIG. 3B illustrates an example of a flow path 120 of a liquid refrigerant located in a lower portion of the battery.

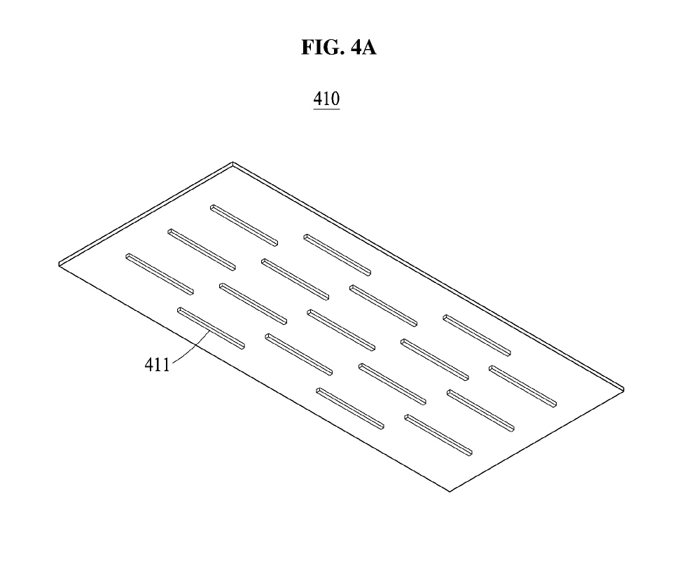

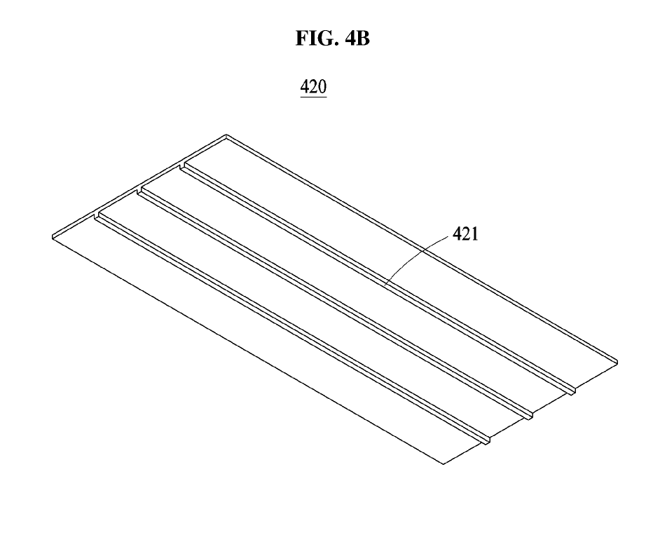

FIGS. 4A and 4B illustrate examples of guides.

FIG. 4A illustrates a set of guides 411 formed on an upper side 410 of a housing, and FIG. 4B illustrates a set of guides 421 formed on an upper side 420 of a housing. Although FIGS. 4A and 4B merely illustrate examples of shapes of the set of guides 411 and 421 for convenience of description, the present disclosure is also applicable to, but not limited to, any type of guides capable of forming a predetermined turbulent flow while guiding an overall flow of an air refrigerant in a housing.

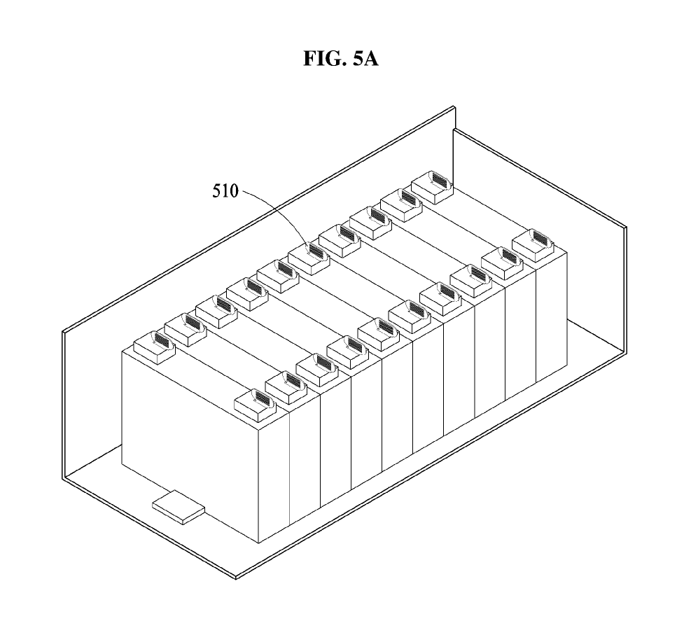

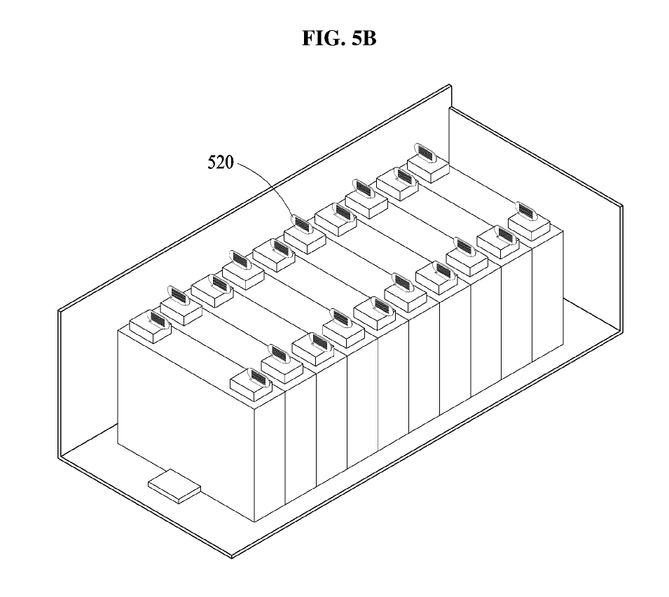

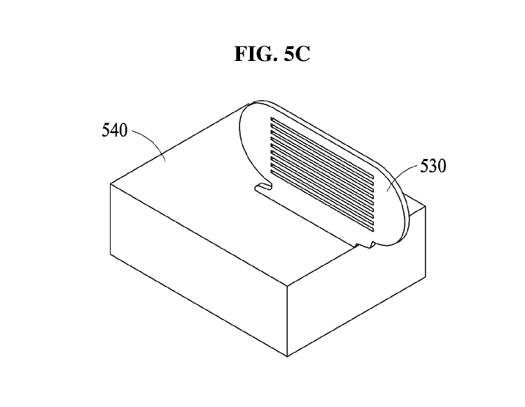

FIGS. 5A, 5B and 5C illustrate examples of heat sinks.

Referring to FIG. 5A, a set of heat sinks 510 is connected to one or more tabs of a battery or battery module. The set of heat sinks 510 in the one or more battery modules may be located in perpendicular to a direction in which an air refrigerant flows, so that each of the tabs is effectively cooled by the air refrigerant. The set of heat sinks 510 is located in a space between the battery and an upper side of a housing.

Referring to FIG. 5B, each of the heat sinks in a set of heat sinks 520 are alternately arranged with each other so that the set of heat sinks 520 are sufficiently exposed to the air refrigerant.

Referring to FIG. 5C, a heat sink 530 is located on a tab 540 of a battery. The heat sink 530 includes a set of grooves through which air refrigerant passes to maximize the air refrigerant contact area with the tab 540 to effect cooling.

Although FIGS. 5A through 5C merely illustrate examples of structures and arrangements of the heat sinks 510 through 530 for convenience of description, the present disclosure is also applicable to, but not limited to, any structure and arraignment of heat sinks to effectively cool a tab of a battery.

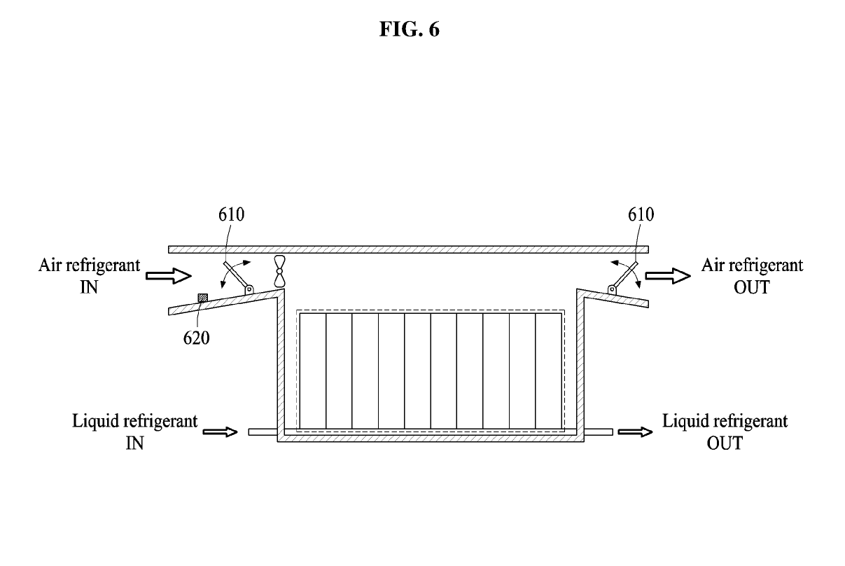

FIG. 6 illustrates an example of a battery system with a water leakage prevention apparatus 610.

Referring to FIG. 6, a water leakage prevention apparatus 610 is located in a flow path of an air refrigerant.

For example, when a typical battery system is flooded, liquid may flow into the housing of the battery through the flow path of the air refrigerant. In this example, the battery may become short-circuited due to the liquid in the housing. To prevent water from leaking into the battery housing, the water leakage prevention apparatus 610 is located in the flow path of the air refrigerant. For example, when the water leakage prevention apparatus 610 is selectively operated, e.g., powered on, the flow path of an air refrigerant flowing into and out of the housing are blocked so that the battery or battery modules are sealed by the housing and the water leakage prevention apparatus 610.

The water leakage prevention apparatus 610 operates based on the state (for example, an on state or an off state) of the battery. In an example, when the battery is in the on state, the water leakage prevention apparatus 610 is powered off to allow cooling of the battery by the air refrigerant. In another example, when the battery is in the off state, cooling of the battery is not requested and to prevent foreign substances from flowing into the housing, the water leakage prevention apparatus 610 is powered on. In still another example, when the state of the battery changes from the on state to the off state and a predetermined amount of time elapses, the water leakage prevention apparatus 610 changes the off state of the battery to the on state, so that the heated battery is cooled for a predetermined amount of time. A predetermined amount of time may be time required to cool the battery to room temperature or a preset temperature (for example, a temperature that is slightly higher than the room temperature and that allows the battery to be left).

Also, the water leakage prevention apparatus 610 operates based on whether liquid flowing into the flow path of the air refrigerant is present. For example, a leakage sensor 620 is located in the flow path of the air refrigerant, to determine whether liquid flowing into the flow path of the air refrigerant is present. In an example, when the leakage sensor 620 senses the liquid flowing into the flow path of the air refrigerant, the water leakage prevention apparatus 610 is powered on to prevent the liquid from flowing into the housing. In another example, when the leakage sensor 620 does not sense the liquid, the water leakage prevention apparatus 610 is powered off to allow the battery to be cooled by the air refrigerant.

The present disclosure is also applicable to, but not limited to, any waterproofing structure capable of preventing liquid from flowing into a housing of a battery, in varying examples.

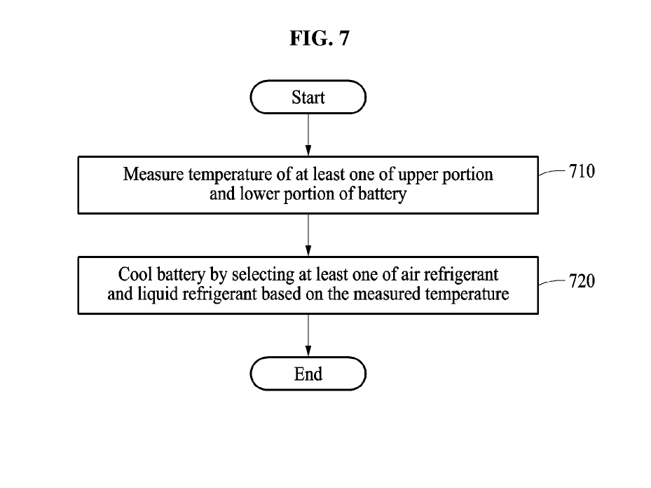

FIG. 7 is a flowchart illustrating an example of a battery thermal management method.

The battery thermal management method of FIG. 7 is performed by, for example, a processor of a battery thermal management apparatus. The battery thermal management apparatus cools a battery using either one or both of an air refrigerant and a liquid refrigerant. The air refrigerant is used to cool an upper portion of the battery, and the liquid refrigerant is used to cool a lower portion of the battery. Examples of operations of the battery thermal management apparatus will be further described with reference to FIG. 7.

In operation 710, the battery thermal management apparatus measures the temperature of either one or both of the upper portion and the lower portion of the battery. For example, a temperature sensor located in each of the upper portion and the lower portion of the battery is used to measure a temperature of either one or both of the upper portion and the lower portion of the battery.

In operation 720, the battery thermal management apparatus cools the battery by selecting either one or both of the air refrigerant and the liquid refrigerant based on the measured temperature.

In an example, when a temperature of each of the upper portion and the lower portion of the battery is less than or equal to a first threshold temperature, the battery thermal management apparatus cools the battery through a natural convection of the air refrigerant. When a battery system is representative of, or included in an EV, a natural convection of air refrigerant flows into the housing of the battery through a flow path of the air refrigerant during driving of the EV, and the battery is cooled.

In another example, when a temperature of either one or both of the upper portion and the lower portion of the battery exceeds the first threshold temperature, the battery thermal management apparatus cools the battery through a forced convection of the air refrigerant induced by an operation of a fan located in the flow path of the air refrigerant.

Generally, during operation of a battery, heat is easily generated in a tab of the battery. For example, in an example, whether the fan is controlled to be selectively operated is determined based on whether the temperature of an upper portion of the battery proximate to the tab is determined to exceed a first threshold temperature, which also determines whether the battery is selected to be cooled through a natural or forced convection of the air refrigerant.

In still another example, when the temperature difference between the upper portion and the lower portion of the battery exceeds a second threshold temperature, the battery thermal management apparatus cools the battery using both the air refrigerant and the liquid refrigerant. In this example, when the temperature difference increases, the life of the battery is likely to decrease. Thus, the upper portion and the lower portion of the battery may be simultaneously cooled using the air refrigerant and the liquid refrigerant. In yet another example, when the temperature of either one or both of the upper portion and the lower portion of the battery exceeds a third threshold temperature, the battery thermal management apparatus effectively cools the battery using both the air refrigerant and the liquid refrigerant.

FIG. 8 illustrates an example of a battery thermal management apparatus 800.

Referring to FIG. 8, the battery thermal management apparatus 800 includes a memory 810 and a processor 820. The memory 810 and the processor 820 communicate with each other via a bus 830.

The memory 810 stores a computer-readable instruction. The processor 820 may perform the above-described operations in response to the instruction in the memory 810 being executed by the processor 820. The memory 810 is, for example, a volatile memory or a non-volatile memory.

The processor 820 includes an apparatus configured to execute instructions or programs or to control the battery thermal management apparatus 800. The processor 820 selectively controls the cooling of a battery using either one or both of an air refrigerant and a liquid refrigerant. The air refrigerant is used to cool an upper portion of the battery, and the liquid refrigerant is used to cool a lower portion of the battery.

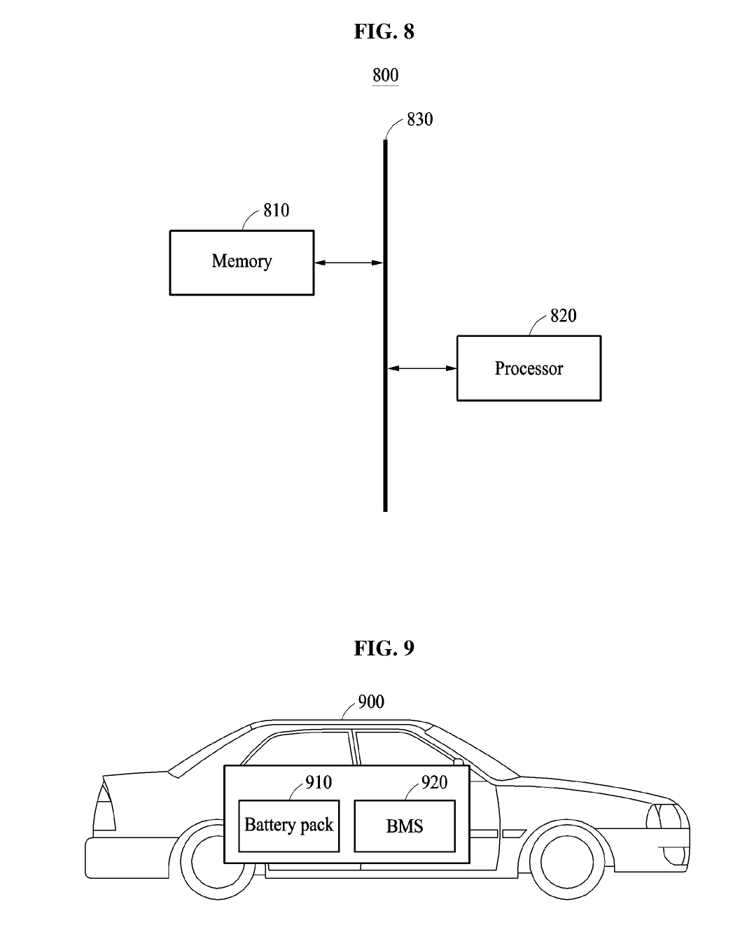

The battery thermal management apparatus 800 is included in, for example, various electronic devices (for example, a vehicle, a walking assistance apparatus, a drone or a mobile terminal) using a battery as a power source, and performs the operations described above with reference to FIGS. 1 through 7. Hereinafter, an example in which the battery thermal management apparatus 800 is included in a vehicle is described with reference to FIG. 9.

FIG. 9 illustrates an example of a vehicle 900.

Referring to FIG. 9, the vehicle 900 includes a battery pack 910 and a BMS 920. The vehicle 900 uses the battery pack 910 as a power source. The vehicle 900 is, for example, an EV or a hybrid vehicle.

The battery pack 910 includes at least one battery module. The battery module includes at least one battery cell.

The BMS 920 monitors whether an abnormality occurs in the battery pack 910, and prevents the battery pack 910 from being overcharged or over-discharged. Also, when a temperature of the battery pack 910 exceeds a first temperature or is less than a second temperature, the BMS 920 controls the temperature of the battery pack 910. The BMS 920 performs cell balancing to equalize states of charge of battery cells included in the battery pack 910.

For example, the BMS 920 includes a battery thermal management apparatus. The BMS 920 allows the battery thermal management apparatus to cool a battery using either one or both of the air refrigerant and the liquid refrigerant.

The above description of FIGS. 1 through 8 is also applicable to the example of FIG. 9, and accordingly is not repeated here.

In prior applications, the performance of a battery or the life of the battery may decrease due to the generated heat. However, as disclosed above, the described examples in FIGS. 1-9 may cool the battery to maintain a constant temperature; thereby, providing an improvement to the battery life.

The battery system 100, the water leakage prevention apparatus 610, the battery thermal management apparatus 800, the BMS 920 and other apparatuses, units, modules, devices, and other components described herein with respect to FIGS. 1-9 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The method in FIG. 7 that performs the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery thermal management apparatus, comprising:
a first flow path configured to flow air refrigerant to cool an upper portion of a battery; and
a second flow path configured to flow liquid refrigerant to cool a lower portion of the battery,
wherein the battery is selectively cooled using the air refrigerant and the liquid refrigerant.

2. The battery thermal management apparatus of claim 1, wherein the first flow path is connected to an upper portion of a housing of the battery.

3. The battery thermal management apparatus of claim 1, wherein the air refrigerant is used to cool one or more tabs of the battery disposed at the upper portion of the battery.

4. The battery thermal management apparatus of claim 3, wherein one of the one or more tabs is connected to a heat sink that is perpendicularly configured to a direction in which the air refrigerant flows.

5. The battery thermal management apparatus of claim 4, wherein the heat sink comprises one or more grooves through which the air refrigerant flows.

6. The battery thermal management apparatus of claim 1, wherein a guide member is configured for turbulent flow of the air refrigerant inside a housing of the battery.

7. The battery thermal management apparatus of claim 6, wherein the guide member is formed on an upper side of the housing.

8. The battery thermal management apparatus of claim 1, wherein the second flow path contacts the lower portion of the battery.

9. The battery thermal management apparatus of claim 1, wherein the battery is cooled selectively using one or both of the air refrigerant and the liquid refrigerant selected based on a temperature of either one or both of the upper portion and the lower portion of the battery.

10. The battery thermal management apparatus of claim 9, wherein
in response to a temperature of each of the upper portion and the lower portion of the battery being less than or equal to a first threshold temperature, the battery is cooled through a natural convection of the air refrigerant; and
in response to a temperature of either one or both of the upper portion and the lower portion of the battery exceeding the first threshold temperature, the battery is cooled through a forced convection of the air refrigerant induced by an operation of a fan located in the first flow path of the air refrigerant.

11. The battery thermal management apparatus of claim 9, wherein, in response to a temperature difference between the upper portion and the lower portion of the battery exceeding a second threshold temperature, the battery is cooled using the air refrigerant and the liquid refrigerant.

12. The battery thermal management apparatus of claim 1, wherein the first flow path is selectively opened and closed based on either one or both of a state of the battery and whether liquid flows into the first flow path.

13. A processor implemented battery thermal management method, comprising:
cooling a battery selectively using either one or both of an air refrigerant to cool an upper portion of a battery and a liquid refrigerant to cool a lower portion of the battery.

14. The battery thermal management method of claim 13, wherein the cooling of the battery comprises:
measuring a temperature of either one or both of the upper portion and the lower portion of the battery; and
cooling the battery by selectively selecting either one or both of the air refrigerant and the liquid refrigerant based on the measured temperature.

15. The battery thermal management method of claim 14, wherein the cooling of the battery by selectively selecting either one or both of the air refrigerant and the liquid refrigerant based on the measured temperature comprises:
in response to a temperature of each of the upper portion and the lower portion of the battery being less than or equal to a first threshold temperature, cooling the battery through a natural convection of the air refrigerant; and
in response to a temperature of either one or both of the upper portion and the lower portion of the battery exceeding the first threshold temperature, cooling the battery through a forced convection of the air refrigerant induced by an operation of a fan located in a flow path of the air refrigerant.

16. The battery thermal management method of claim 14, wherein the cooling of the battery by selectively selecting either one or both of the air refrigerant and the liquid refrigerant based on the measured temperature comprises, in response to a temperature difference between the upper portion and the lower portion of the battery exceeding a second threshold temperature, cooling the battery using the air refrigerant and the liquid refrigerant.

17. The battery thermal management method of claim 13, wherein a flow path of the air refrigerant is connected to an upper portion of a housing of the battery.

18. The battery thermal management method of claim 13, wherein the air refrigerant is used to cool one or more tabs of the battery located in the upper portion of the battery.

19. The battery thermal management method of claim 13, wherein a flow path of the liquid refrigerant is in contact with the lower portion of the battery.

20. A non-transitory computer-readable storage medium storing instructions that, when executed by a processor, cause the processor to perform the battery thermal management method of claim 13.
